(19) United States
(12) Patent Application Publication
(10) Pub. No.: US 2016/0378091 A1
(43) Pub. Date: Dec. 29, 2016

(54) ADAPTIVE AIR COOLING

(71) Applicant: QUALCOMM Incorporated, San Diego, CA (US)

(72) Inventor: Jian SHEN, San Diego, CA (US)

(21) Appl. No.: 14/818,797

(22) Filed: Aug. 5, 2015

Related U.S. Application Data
(60) Provisional application No. 62/183,651, filed on Jun. 23, 2015.

(51) Int. Cl. G05B 19/401

(52) U.S. Cl. CPC G05B 19/401; G05B 2219/37431

(57) ABSTRACT

A method, an apparatus, and a computer program product for thermal management are provided. The apparatus may be a mobile device, a UE, a base station, a tablet computer, a smart watch, a head-mounted display, a portable media player, a personal navigation device, a wearable device, etc. The apparatus determines a direction of a natural draft relative to the apparatus. The apparatus generates an airflow within the apparatus in the direction of the natural draft. To determine the direction of the natural draft, the apparatus may detect an orientation of the apparatus and determine an upward direction based on the detected orientation. The upward direction may be generally aligned with the natural draft.

### CROSS-REFERENCE TO RELATED APPLICATION

This application claims the benefit of U.S. Provisional Application Ser. No. 62/183,651, entitled “ADAPTIVE AIR COOLING” and filed on Jun. 23, 2015, which is expressly incorporated by reference herein in its entirety.

### BACKGROUND

Field

The present disclosure relates generally to thermal management of electronic devices and systems, and more particularly, to adaptive air cooling of an electronic device based on the direction of a natural draft relative to the device.

Background

As mobile computing devices become more integrated and include more computing power, they may generate more heat. For example, a modern smart phone may include one or more highly integrated components known as a system on a chip (“SoC”) or a system in package (“SiP”). Each SoC or SiP may have one or more integrated circuits (“ICs”) with one or more processor cores, memory circuits, graphics processing circuits, radio frequency communication circuits, and other digital and analog circuits. Further, multiple SoCs or SiPs may be stacked in a package on package (“PoP”) configuration. A common PoP configuration includes one SoC or SiP package that has processing and other circuits, with a second stacked package that includes volatile and/or non-volatile memory components.

These highly integrated processing components may generate a large amount of heat within a tightly integrated packaging structure. Additionally, many manufacturers desire to increase the number of processing cores and processor clock speeds, further increasing the amount of heat generated in the package. For mobile computing device processors especially, heat may become a limiting factor to computing performance.

Typically, mobile computing devices may include passive heat dissipation components (e.g., heat sinks, etc.) that transfer heat from the processor package and/or other components that require heat dissipation to an exterior surface of the mobile computing device. However, the overall ability to dissipate heat from the mobile computing device may be limited by the thermal conduction paths between the exterior surfaces of the mobile computing device and the environment (e.g., air or other medium in contact with the exterior surface). As power consumption of mobile processors continues to increase, passive heat dissipation techniques may no longer be able to keep up with the heat generated by the mobile computing device. While there are known techniques for active cooling, such as cooling fans, these techniques may be difficult to integrate into the limited enclosure space of mobile computing devices because of their bulky form factors and their high level of power consumption.

### SUMMARY

In an aspect of the disclosure, a method, a computer program product, and an apparatus for thermal management are provided. The apparatus may a mobile device, a UE, a base station, a tablet computer, a smart watch, a head-mounted display, a portable media player, a personal navigation device, a wearable device, etc. The apparatus determines a direction of a natural draft relative to the apparatus. The apparatus generates an airflow within the apparatus in the direction of the natural draft. In one configuration, to determine the direction of the natural draft, the apparatus may detect an orientation of the apparatus and determine an upward direction based on the detected orientation. The upward direction may be generally aligned with the natural draft. In one configuration, to determine the direction of the natural draft, the apparatus may force air to flow in a first direction within the apparatus, measure a first airflow caused by the forced air flow in the first direction, force air to flow in a second different direction within the apparatus, measure a second airflow caused by the forced air flow in the second direction, and determine a direction based on the first airflow and the second airflow. The determined direction may be generally aligned with the natural draft.

### BRIEF DESCRIPTION OF THE DRAWINGS

FIG. 1 is a diagram illustrating a method that enhances the cooling effect of the natural draft.

FIG. 2 is a diagram illustrating different directions of natural draft in relation to a mobile device with the mobile device at different orientations.

FIG. 3 is a diagram illustrating a top view of a mobile device and a cross section side view of the mobile device along line A-A.

FIG. 4 is a flowchart of a method of managing the temperature of a device.

FIG. 5 is a flowchart of a method of determining the direction of a natural draft relative to a device.

FIG. 6 is a flowchart of a method of determining the direction of a natural draft relative to a device.

FIG. 7 is a conceptual data flow diagram illustrating the flow between different modules/means/components in an exemplary apparatus that implements the methods of FIGS. 4, 5, and 6.

FIG. 8 is a diagram illustrating an example of a hardware implementation for an apparatus employing a processing system that implements the methods of FIGS. 4, 5, and 6.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of a thermal management mechanism for mobile devices will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

Traditional fans used in larger systems such as desktops are too bulky and power consuming for mobile devices. In order to overcome deficiencies of the traditional fans, milli-scale fans with sizes of about 1 mm in diameter or less are being developed for placement inside the enclosure of mobile devices. In addition to their small sizes, milli-scale fans consume much less power than traditional fans.

Natural draft is the movement of air into and out of containers (e.g., enclosures of mobile device), resulting from air buoyancy. Buoyancy occurs due to a difference in inside-to-outside air density resulting from temperature and moisture differences. The result is either a positive or negative buoyancy force. The greater the thermal difference between the inside of the container and the outside of the container, and the greater the height of the container, the greater the buoyancy force, and thus the natural draft.

The natural draft helps drive natural ventilation and infiltration for the mobile device, which brings down the temperature of the mobile device. Thus the greater the natural draft, the better the cooling of the mobile device. In the case of the mobile device with milli-scale fans, the airflow generated by milli-scale fans within a mobile device may conflict with the direction of natural draft, depending on the orientation of the mobile device. Thus the force of natural draft may be reduced by the airflow generated by milli-scale fans. This may have a detrimental impact on the cooling of the mobile device.

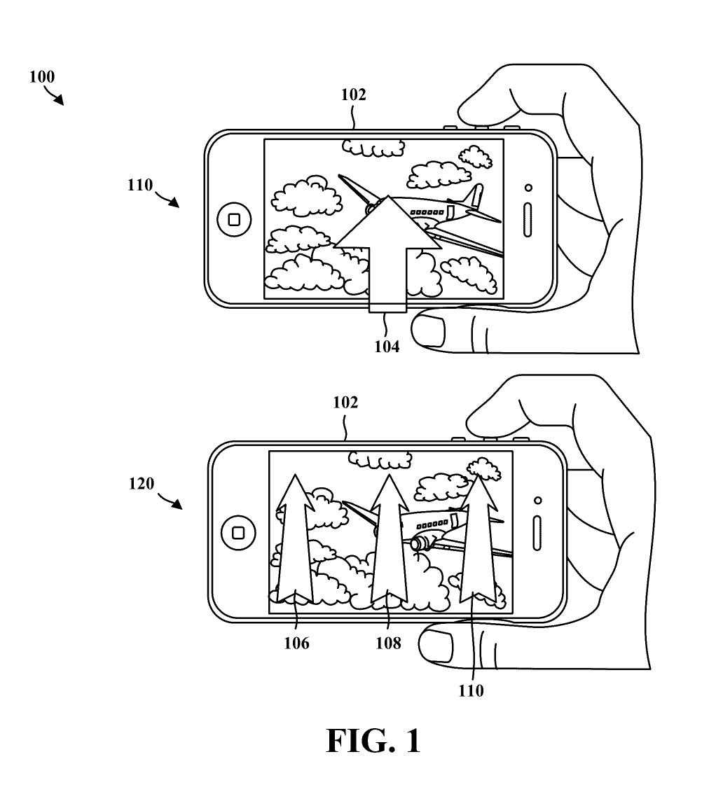

FIG. 1 is a diagram 100 illustrating a method that enhances the cooling effect of a natural draft. The method is described in illustrations 110 and 120. At illustration 110, the direction of the natural draft within the shell of mobile device 102 is determined to be in the direction of 104. Once the natural draft direction 104 is determined, at illustration 120, the mobile device 102 generates airflows 106, 108, and 110 (e.g., by milli-scale fans) within the shell in the same direction as the natural draft direction 104. This way, the airflow generated by the milli-scale fans may augment the force of the natural draft, thus improving the cooling of the mobile device.

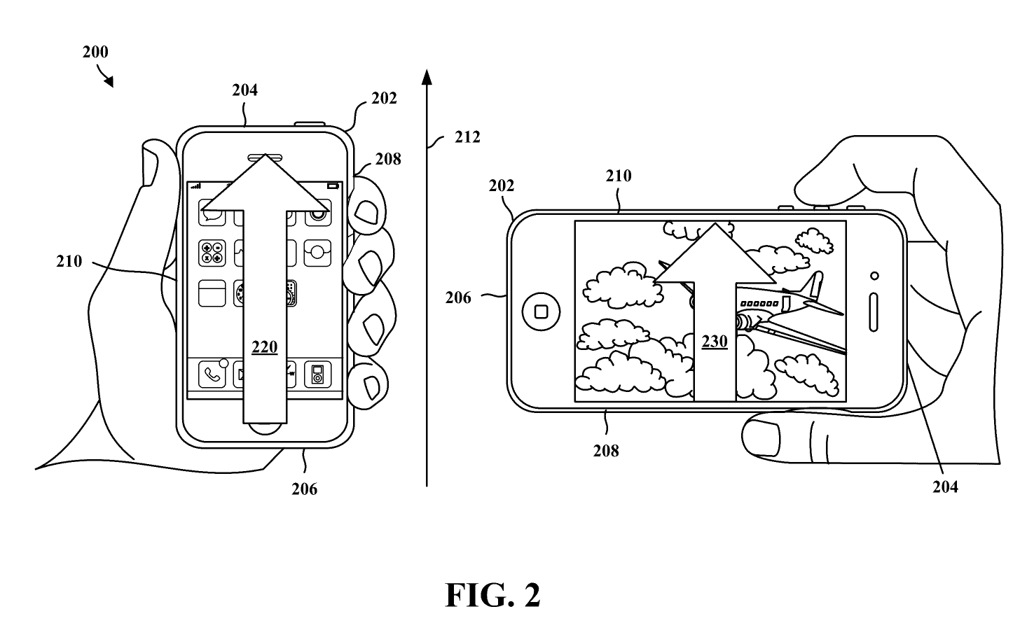

FIG. 2 is a diagram 200 illustrating different directions of natural draft in relation to a mobile device with the mobile device at different orientations. As illustrated in diagram 200, a mobile device 202 has four edges 204, 206, 208, and 210. The left side of diagram 200 shows that the mobile device 202 is held vertically, in which the edge 204 is up, the edge 206 is down, and the edges 210 and 208 on the left and right, respectively. The right side of diagram 200 shows that the mobile device 202 is held horizontally, in which the edge 210 is up, the edge 208 is down, and the edges 206 and 204 on the left and right, respectively.

In general, heat rises in the upward direction 212. This is because heated molecules have a tendency to become agitated and to move about. Because of the motions of the heated molecules, the molecules collide with each other creating more space in between them. This makes heated air less dense, thus lighter. Lighter air is forced to rise by the heavier air, which displaces the lighter air at the bottom of a container. Therefore the upward direction 212 may be considered to be generally aligned with the natural draft.

The left side of diagram 200 shows, when the mobile device 202 is held vertically, the natural draft direction 220 is aligned with the upward direction 212, which is from edge 206 to edge 204. The right side of diagram 200 shows, when the mobile device 202 is held horizontally, the natural draft direction 230 is also aligned with the upward direction 212, which is from edge 208 to edge 210. Therefore, when the orientation of the mobile device 202 changes, the natural draft direction relative to the structure, e.g., the edges 204, 206, 208, 210, of the mobile device 202 changes accordingly.

In one configuration, the mobile device 202 uses sensors to detect the orientation of the mobile device 202. In this configuration, the mobile device 202 determines the upward direction 212 based on the detected orientation and directs milli-scale fans within the mobile device to pump air upward in a direction aligned with the natural upward draft 220 and 230. This pumping of air in the direction of the natural draft may strengthen the force of natural draft and improve the cooling of the mobile device.

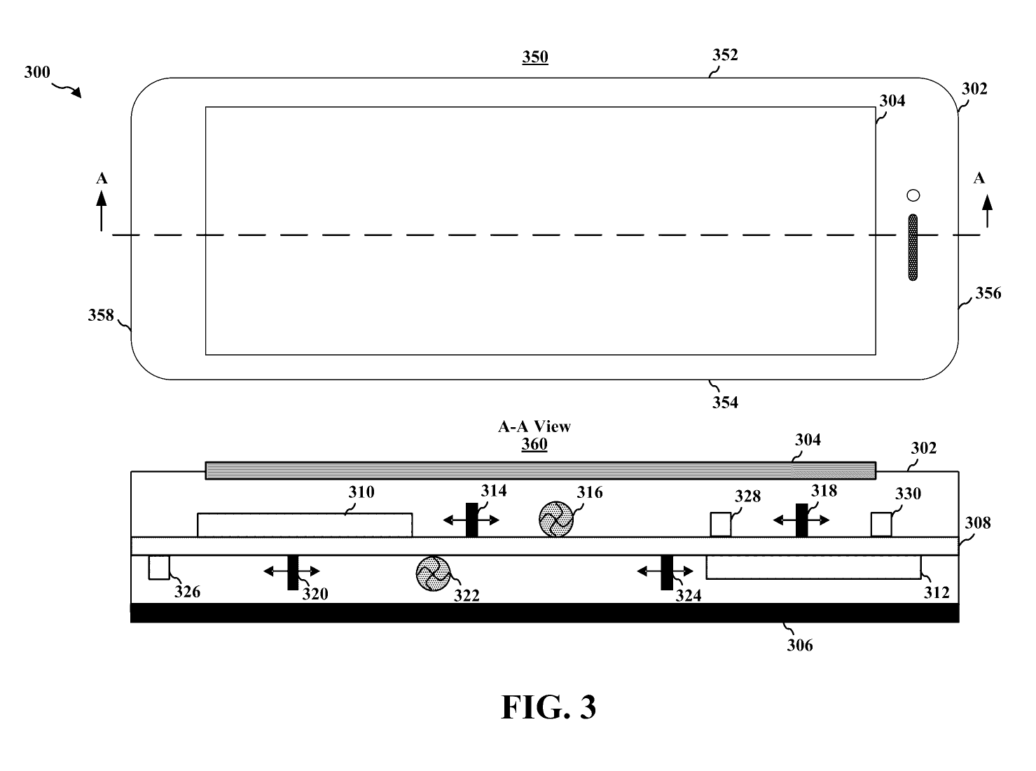

FIG. 3 is a diagram illustrating a top view 350 of a mobile device 300 and a cross section side view 360 of the mobile device along line A-A. The mobile device 300 may be a smart phone, a tablet computer, a smart watch, a head-mounted display, a portable media player, a personal navigation device, a wearable device, etc. The mobile device 300 may also be referred to as a mobile station, a user equipment (UE), a subscriber station, a mobile unit, a subscriber unit, a wireless unit, a remote unit, a wireless device, a wireless communications device, a remote device, a mobile subscriber station, an access terminal, a mobile terminal, a wireless terminal, a remote terminal, a handset, a user agent, a mobile client, a client, or some other suitable terminology.

The mobile device 300 includes an enclosure 302 that encloses device components, including integrated circuit (IC) packages 310 and 312, a printed circuit board (PCB) 308, a sensor 326, air flow meters 328 and 330, and milli-scale fans 314, 316, 318, 320, 322, and 324. The enclosure 302 has four sides or edges 352, 354, 356, and 358. A surface of the enclosure 302 may include a liquid-crystal display (LCD) 304. Another surface of the enclosure 302 may be a back panel 306. Although only two air flow meters 328 and 330 are shown, the mobile device 300 may include additional air flow meters. For example, a pair of air flow meters may be associated with each milli-scale fan.

The IC packages 310 and 312 may be mounted on the PCB 308. The IC packages 310 and 312, as well as other components of the mobile device 300, may emit heat while performing their functions. The milli-scale fans 314-324 may be selectively turned on to force air to circulate within the enclosure 302 to cool down the mobile device 300, or to maintain the temperature at a steady state temperature less than a temperature that may have a detrimental effect on the operation of the device.

The milli-scale fans 314-324 may be configured to pump air at different directions. For example, one or more of the milli-scale fans may be configured to pump air in one fixed direction, or may pump air in two directions that are opposite each other. One or more of the milli-scale fans may be configured to be adjusted to pump air in any direction. For example, one or more of milli-scale fans 314, 318, 320, and 324 may be configured to pump air toward either the edge 358 of the enclosure 302 or the edge 356 of the enclosure, and each of milli-scale fans 316 and 322 may be configured to pump air toward either the edge 352 of the enclosure 302 or the edge 354 of the enclosure.

In one configuration, when a natural draft direction is determined, the milli-scale fans that can pump air in that direction may be selected and activated. The selected milli-scale fans generate airflow within the enclosure 302 in the direction of the natural draft, while other milli-scale fans are turned off. The activation of a milli-scale fan may include, in the case of bidirectional fan, selecting the direction in which the fan will force air, or in the case of an adjustable fan, adjusting the orientation of the fan so that the direction in which the fan will force air is aligned with the direction of natural draft.

The sensor 326 may be used to detect the orientation of the mobile device 300. In one configuration, the sensor 326 may be an accelerometer. The air flow meter 328 may be used to obtain a measure of the airflow generated by the milli-scale fan 318 when the milli-scale fan 318 pumps air toward the edge 358 of the enclosure 302. The measure may be a speed or strength of the airflow. The air flow meter 330 may be used to obtain a similar measure of the airflow generated by the milli-scale fan 318 when the milli-scale fan 318 pumps air toward the edge 356 of the enclosure 302.

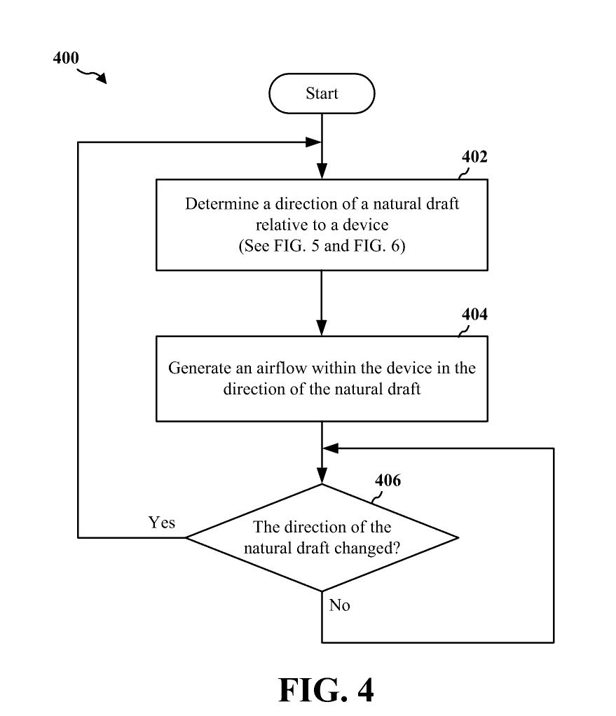

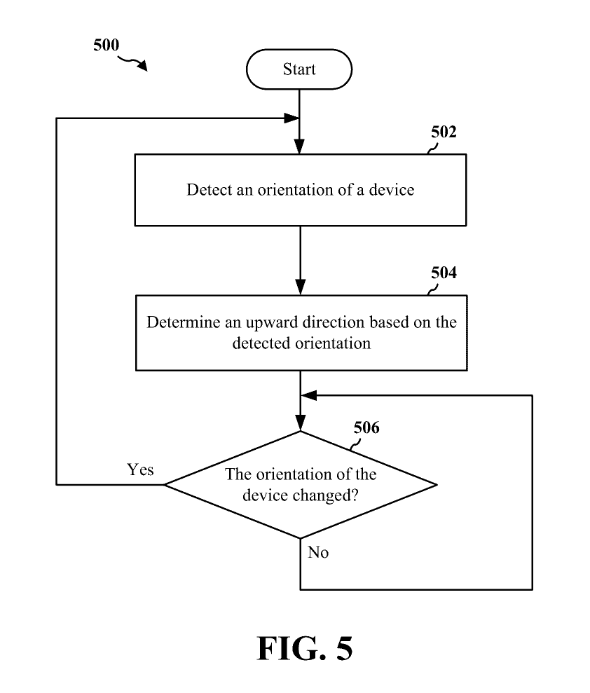

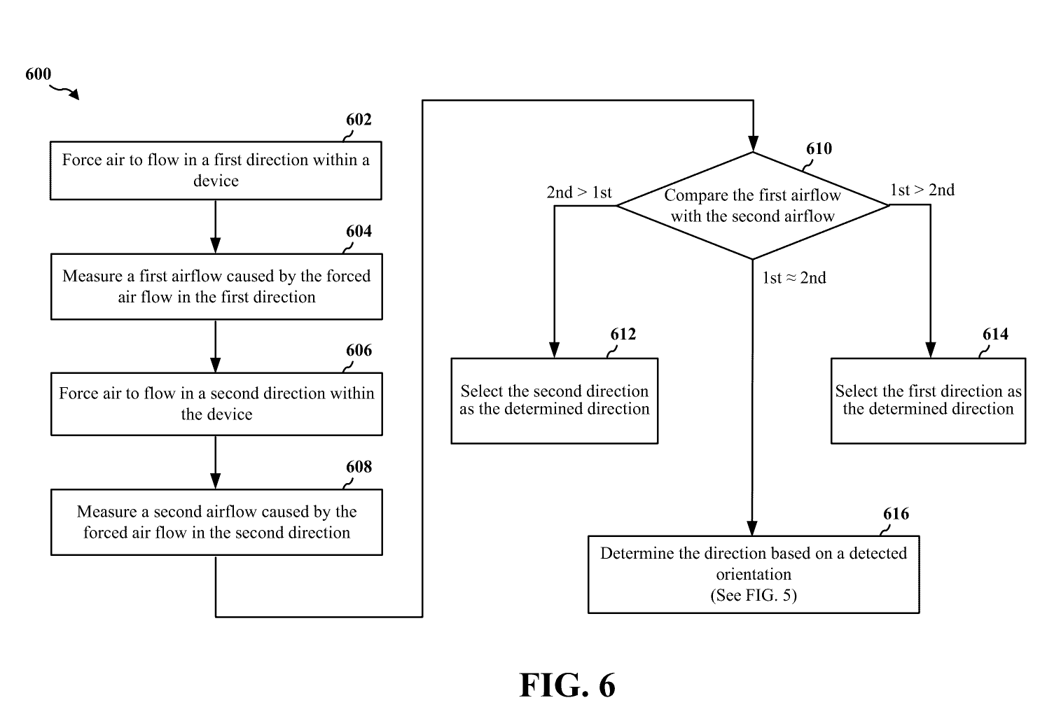

FIG. 4 is a flowchart 400 of a method of managing the temperature of a device. Specifically, flowchart 400 describes a method of an adaptive air cooling using one or more milli-scale fans. The method may be performed by a device (e.g., the mobile device 102, 300, or the apparatus 702/702′). In one configuration, the device may be totally enclosed without any inlet or outlet for air ventilation. In this configuration, the enclosure of the device does not include air vents, but air may still get into and out of the inside of the device through gaps in the enclosure (e.g., where the edges meet). In one configuration, the enclosure of the device may be water resistant or waterproof. At 402, the device determines a direction of a natural draft relative to the device. The direction of the natural draft may be an upward direction, i.e., the direction toward the sky. The direction of the natural draft may be any direction in which a buoyancy force exists. In one configuration, the direction of a natural draft relative to the device is determined as described with respect to FIG. 5. In another configuration, the direction of a natural draft relative to the device is determined as described with respect to FIG. 6.

At 404, the device generates an airflow within the enclosure of the device in the direction of the natural draft. In one configuration, one or more milli-scale fans that can pump air in the direction of the natural draft are selected to generate the airflow.

At 406, the device determines whether the direction of the natural draft has changed. In one configuration, the device determines that the direction of the natural draft has changed by using a sensor to detect the changes in the orientation of the device. If the direction of the natural draft has changed, the method loops back to 402 to determine the new direction of the natural draft. If the direction of the natural draft has not changed, the method loops back to 406 to keep monitoring the change of the natural draft direction.

This method of adaptive air cooling generates larger airflow to dissipate the heat inside the enclosure of a device. Thus thermal management using this method may be more effective. This method of adaptive air cooling may also save power consumption of the device because less power is needed to operate the milli-scale fans as this method allows for selectively turning on a limited number of fans, as opposed to just automatically turning on all fans. This method is also transparent to the users. Users do not need to recognize the orientation of the device and adjust the interior fans.

FIG. 5 is a flowchart 500 of a method of determining the direction of a natural draft relative to a device. At 502, the device detects an orientation of the device. In one configuration, the orientation is detected using at least one sensor, e.g., an accelerometer 326.

At 504, the device determines an upward direction 212 based on the detected orientation. The upward direction 212 is generally aligned with the direction of natural draft. In one configuration, the upward direction 212 is determined based on the detected orientation of the device.

At 506, the device determines whether the orientation of the device has changed. In one configuration, the device uses a sensor to determine that the orientation of the device has changed. If the orientation of the device has changed, the method loops back to 502 to detect the new orientation of the device. If the orientation of the device has not changed, the method loops back to 506 to keep monitoring the orientation of the device.

FIG. 6 is a flowchart 600 of a method of determining the direction of a natural draft relative to a device. At 602, the device forces air to flow in a first direction within the device. In one configuration, one or more fans (e.g., milli-scale fan 318) are turned on to force air to flow in the first direction (e.g., to the edge 358).

At 604, the device measures a first airflow caused by the forced air flow in the first direction. The first airflow may be a measure of the strength or speed of the forced air flow in the first direction. The first airflow may be obtained using an air flow meter 328.

At 606, the device forces air to flow in a second direction within the device. In one configuration, the same one or more fans (e.g., milli-scale fan 318) that forced air to flow in the first direction are adjusted and turned on to force air to flow in the second direction (e.g., to the edge 356). The first and second directions may be opposite to each other. In one configuration, the device stops forcing air to flow in the first direction and idles for a period of time before forcing air to flow in the second direction. The time period for forcing air to flow in the first direction and the time period for forcing air to flow in the second direction is thus neither overlapping nor is it continuous in that there is an idle period of time between the first and second forced airflows. The idle period ensures that there is limited or no interference from any remaining first airflow when measuring the second airflow.

At 608, the device measures a second airflow caused by the forced air flow in the second direction. As with the first air flow, the second airflow may be a measure of the strength or speed of the forced air flow in the second direction. The second airflow may be obtained using an air flow meter 330.

At 610, the device compares the measurements of the first airflow with the measurements of the second airflow. If the second airflow has faster speed and/or is stronger than the first airflow, at 612, the device selects the second direction as the determined direction. If the first airflow has faster speed and/or is stronger than the second airflow, at 614, the device selects the first direction as the determined direction. The direction selection by the device may also be based on a threshold criterion. For example, the air flow direction having an air flow measure, e.g., speed or strength, that is greater than the speed or strength of the other air flow direction by a threshold percentage, e.g., 10%, may be selected. In one configuration, the determined direction aligns with the direction of the natural draft.

If the measurements of the first airflow and the second airflow are substantially equal, at 616, the device determines the direction based on a detected orientation. In one configuration, the operations described above in FIG. 5 are performed at 616. In one configuration, measurements of two airflows are considered substantially equal when the differences between the two measurements are within a predetermined threshold value of each other. For example, in one configuration, measurements of two airflows are considered substantially equal when the smaller one of the two measurements is more than 90% of the larger one of the two measurements. In other words, the airflow measurements are within 10% of each other.

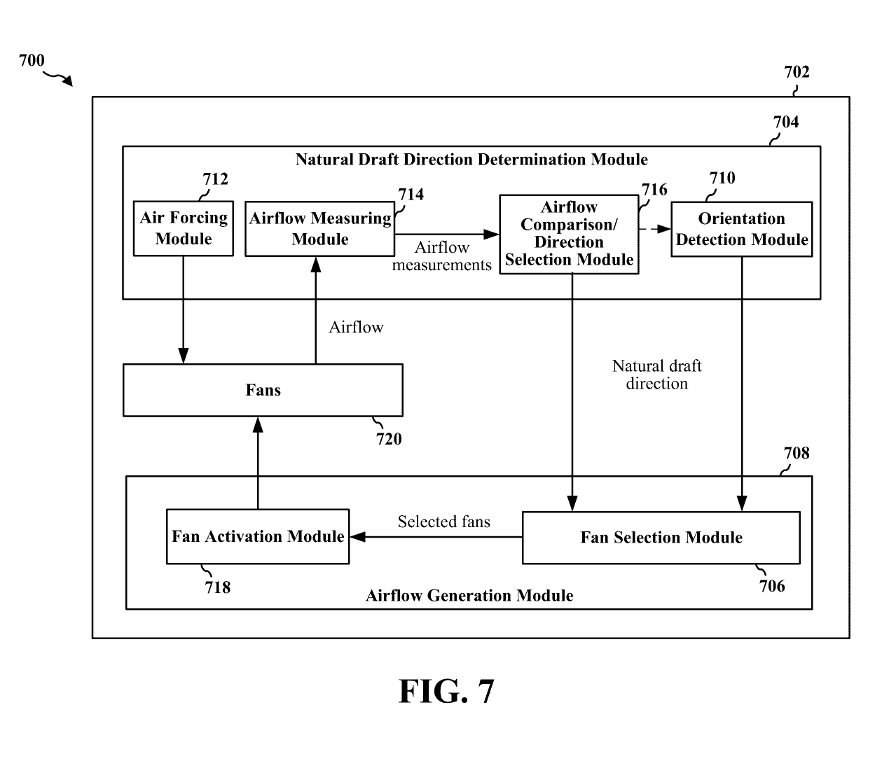

FIG. 7 is a conceptual data flow diagram 700 illustrating the flow between different modules/means/components in an exemplary apparatus 702 configured to implement the methods of FIGS. 4, 5 and 6. The apparatus 702 may be a mobile device, a UE, a base station, a tablet computer, a smart watch, a head-mounted display, a portable media player, a personal navigation device, a wearable device, etc. The apparatus 702 includes one or more fans 720. The apparatus 702 includes a natural draft direction determination module 704 that determines the direction of natural draft. The apparatus 702 also includes an airflow generation module 708 that generates airflows in the direction of the natural draft.

The natural draft direction determination module 704 includes an air forcing module 712, an airflow measuring module 714, an airflow comparison/direction selection module 716, and an orientation detection module 710. The airflow generation module 708 includes a fan activation module 718 and a fan selection module 706.

In one configuration, the direction of the natural draft is determined based on orientation. In this configuration, the orientation detection module 710 detects the orientation of the apparatus 702 and determines the direction of natural draft based on the orientation. The orientation detection module may include a sensor (e.g., accelerometer 326) that outputs a signal corresponding to the orientation of the apparatus 702, which also corresponds to the direction of the natural draft. A signal corresponding to the natural draft direction determined by the orientation detection module 710 is sent to the fan selection module 706. In this configuration, the orientation detection module 710 performs the method described above with reference to FIG. 5.

In another configuration, the direction of natural draft is determined based on forced air flow measurements. In this configuration, the air forcing module 712 forces air to flow in a first direction and a second direction. In one configuration, the air forcing module 712 controls one or more of the fans 720 to force air to flow in the designated directions. The one or more of the fans 720 generates the corresponding airflow, which is measured by the airflow measuring module 714. The airflow measuring module 714 measures a first airflow in the first direction and a second airflow in the second direction, and sends the airflow measurements to the airflow comparison/direction selection module 716. The airflow measuring module 714 may include air flow meters 328 and 330.

The airflow comparison/direction selection module 716 compares the measurements of the first airflow and the second airflow. The airflow comparison/direction selection module 716 selects a direction having a faster and/or stronger airflow as the direction of natural draft. The selected direction is sent to the fan selection module 706 as a natural draft direction. If the airflow comparison/direction selection module 716 determines that the measurements of the first airflow and the second airflow are substantially equal, the airflow comparison/direction selection module 716 invokes the orientation detection module 710 to determine the direction of natural draft, as described above. In one configuration, the air forcing module 712, the airflow measuring module 714, the airflow comparison/direction selection module 716, and the orientation detection module 710 function together to perform the method described above with reference to FIG. 6.

The fan selection module 706 receives the direction of the natural draft from the airflow comparison/direction selection module 716 or the orientation detection module 710. The fan selection module 706 selects the fans that can pump air in the direction of the natural draft. For example, the fan selection module 706 may include a look-up table of fans and corresponding orientations of each of the fans within the apparatus 702. Based on this information, the fan selection module 706 may select one or more of the fans 720 oriented, or capable of being oriented through directional adjustment, so as to output air in the direction of the natural draft.

The fan activation module 718 receives the list of selected fans from the fan selection module 706 and sends commands to the fans 720 to activate the selected fans. In one configuration, the fan activation module 718 activates the selected fans by turning on the selected fans having an orientation generally aligned with the direction of the natural draft so as to provide airflow in the direction of the natural draft. In one configuration, the fan activation module 718 activates the selected fans by adjusting the orientation of the selected fans so that the selected fans pump air in the direction of the natural draft.

The apparatus 702 may include additional modules that perform each of the blocks of the algorithm in the aforementioned flowcharts of FIGS. 4-6. As such, each block in the aforementioned flowcharts of FIGS. 4-6 may be performed by a module and the apparatus 702 may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

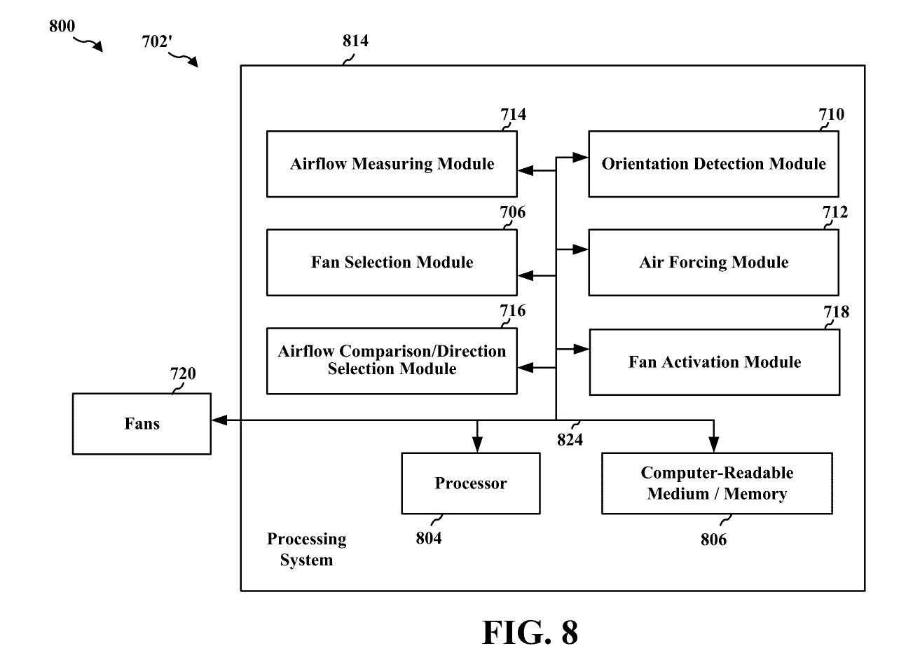

FIG. 8 is a diagram 800 illustrating an example of a hardware implementation for an apparatus 702′ employing a processing system 814 that implements the methods of FIGS. 4, 5 and 6. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 804, the modules 706, 710, 712, 714, 716, 718, and the computer-readable medium/memory 806. The bus 824 may also link various other circuits such as timing sources, peripherals, voltage regulators, and power management circuits, which are well known in the art, and therefore, will not be described any further.

The processing system 814 includes a processor 804 coupled to a computer-readable medium/memory 806. The processor 804 is responsible for general processing, including the execution of software stored on the computer-readable medium/memory 806. The software, when executed by the processor 804, causes the processing system 814 to perform the various functions described supra for any particular apparatus. The computer-readable medium/memory 806 may also be used for storing data that is manipulated by the processor 804 when executing software. The processing system further includes at least one of the modules 706, 710, 712, 714, 716, and 718. The modules may be software modules running in the processor 804, resident/stored in the computer readable medium/memory 806, one or more hardware modules coupled to the processor 804, or some combination thereof

In one configuration, the apparatus 702/702′ for thermal management includes means for determining a direction of a natural draft relative to the apparatus 702/702′, and means for generating an airflow within the apparatus 702/702′ in the direction of the natural draft.

In one configuration, the means for determining a direction of a natural draft may include an orientation detection module 710 configured to detect an orientation of the apparatus 702/702′, and to determine an upward direction based on the detected orientation. The orientation detection module 710 may include an orientation sensor 326, e.g., accelerometer. In another configuration, the means for determining a direction of a natural draft may include an air forcing module 712 configured to force air to flow in a first direction within the apparatus 702/702′ and in a second direction, different from the first direction, within the apparatus 702/702′. The air forcing module 712 may be configured to turn on one or more fans 314, 316, 318, 320, 322, 324 in the first direction and the second direction at different times, and may further include the one or more fans. The means for determining a direction of a natural draft may also include an airflow measuring module 714 configured to measure a first airflow caused by the forced air flow in the first direction, and a second airflow caused by the forced air flow in the second direction. The airflow measuring module 714 may include one or more air flow meters 328, 330 positioned adjacent a fan. The means for determining a direction of a natural draft may further include an airflow comparison/direction selection module 716 configured to determine a direction based on the first airflow and the second airflow.

In one configuration, the airflow comparison/direction selection module 716 of the means for determining a direction of a natural draft may be further configured to compare the first airflow, e.g., a measure of the speed or strength of the air being forced in the first direction, with the second airflow, e.g., a measure of the speed or strength of the air being forced in the second direction, and select one of the first direction and the second direction as the determined direction based on the comparing of the first airflow with the second airflow. For example, the strength or speed of the first and second airflows may be compared and the direction providing an airflow having a strength or speed greater than the other airflow by a threshold criterion may be selected as the determined direction. In one configuration, to determine the direction, the airflow comparison/direction selection module 716 of the means for determining a direction of a natural draft may be further configured to determine the direction based on a detected orientation of the apparatus 702/702′ in response to the measure of the first airflow being within a threshold criterion of to the measure of the second airflow. In this configuration, the airflow comparison/direction selection module 716 may include an orientation sensor 326 that detects the orientation of the apparatus 702/702′.

The means for generating an airflow within the apparatus 702/702′ may include a fan activation module 718 configured to activate at least one of the fans 314, 316, 318, 320, 322, 324 within the apparatus 702/702′. The means for generating an airflow within the apparatus 702/702′ may also include one or more fans 314, 316, 318, 320, 322, 324. The at least one activated fan 314, 316, 318, 320, 322, 324 has an orientation generally aligned with the direction of the natural draft. In one configuration, the apparatus 702/702′ may further include means for selecting the at least one activated fan from a plurality of fans 314, 316, 318, 320, 322, 324 associated with the apparatus 702/702′. The means for selecting the at least one activated fan may include a fan selection module 706 configured to select one or more fans from the fans 720 based on the natural draft direction.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of managing a temperature of a device, comprising:
determining a direction of a natural draft relative to the device; and
generating an airflow within the device in the direction of the natural draft.

2. The method of claim 1, wherein the determining the direction of the natural draft comprises:
detecting an orientation of the device; and
determining an upward direction based on the detected orientation.

3. The method of claim 2, wherein the orientation is detected using at least one sensor.

4. The method of claim 1, wherein the determining the direction of the natural draft comprises:
forcing air to flow in a first direction within the device;
measuring a first airflow caused by the forced air flowing in the first direction;
forcing air to flow in a second direction within the device, wherein the second direction is different than the first direction;
measuring a second airflow caused by the forced air flowing in the second direction; and
determining the direction of the natural draft based on the first airflow and the second airflow.

5. The method of claim 4, wherein air is forced in the first direction during a first time period, air is forced in the second direction during a second time period, and the first time period and the second time period are non-overlapping and non-continuous.

6. The method of claim 4, wherein the determining the direction of the natural draft comprises:
comparing the first airflow with the second airflow; and
selecting one of the first direction or the second direction as the determined direction of the natural draft based on the comparing of the first airflow with the second airflow.

7. The method of claim 6, wherein:
the selected direction corresponds to the first direction when the first airflow is greater than the second airflow by a threshold criterion; and
the selected direction corresponds to the second direction when the second airflow is greater than the first airflow by the threshold criterion.

8. The method of claim 6, wherein the determining the direction of the natural draft further comprises:
determining the direction of the natural draft based on a detected orientation of the device in response to a difference between the first airflow and the second airflow being less than a threshold value.

9. The method of claim 1, wherein the generating the airflow within the device comprises activating at least one fan within the device, the at least one activated fan having an orientation generally aligned with the direction of the natural draft.

10. The method of claim 9, further comprising selecting the at least one activated fan from a plurality of fans associated with the device.

11. An apparatus for managing a temperature, comprising:
means for determining a direction of a natural draft relative to the apparatus; and
means for generating an airflow within the apparatus in the direction of the natural draft.

12. The apparatus of claim 11, wherein the means for determining the direction of the natural draft is configured to:
detect an orientation of the apparatus; and
determine an upward direction based on the detected orientation.

13. The apparatus of claim 12, wherein the orientation is detected using at least one sensor.

14. The apparatus of claim 12, wherein the means for determining the direction of the natural draft is configured to:
force air to flow in a first direction within the apparatus;
measure a first airflow caused by the forced air flowing in the first direction;
force air to flow in a second direction within the apparatus, wherein the second direction is different than the first direction;
measure a second airflow caused by the forced air flowing the second direction; and
determine the direction of the natural draft based on the first airflow and the second airflow.

15. The apparatus of claim 14, wherein air is forced in the first direction during a first time period, air is forced in the second direction during a second time period, and the first time period and the second time period are non-overlapping and non-continuous.

16. The apparatus of claim 14, wherein, to determine the direction of the natural draft, the means for determining the direction of the natural draft is further configured to:
compare the first airflow with the second airflow; and
select one of the first direction or the second direction as the determined direction of the natural draft based on the comparing of the first airflow with the second airflow.

17. The apparatus of claim 16, wherein:
the selected direction corresponds to the first direction when the first airflow is greater than the second airflow by a threshold criterion; and
the selected direction corresponds to the second direction when the second airflow is greater than the first airflow by the threshold criterion.

18. The apparatus of claim 16, wherein, to determine the direction of the natural draft, the means for determining the direction of the natural draft is further configured to:
determine the direction of the natural draft based on a detected orientation of the apparatus in response to a difference between the first airflow and the second airflow being less than a threshold value.

19. The apparatus of claim 12, wherein the means for generating the airflow within the apparatus is configured to activate at least one fan within the apparatus, the at least one activated fan having an orientation generally aligned with the direction of the natural draft.

20. The apparatus of claim 19, further comprising means for selecting the at least one activated fan from a plurality of fans associated with the apparatus.

21. An apparatus for managing a temperature, comprising:
a memory; and
at least one processor coupled to the memory and configured to:
determine a direction of a natural draft relative to the apparatus; and
generate an airflow within the apparatus in the direction of the natural draft.

22. The apparatus of claim 21, wherein, to determine the direction of the natural draft, the at least one processor is further configured to:
detect an orientation of the apparatus; and
determine an upward direction based on the detected orientation.

23. The apparatus of claim 22, wherein the orientation is detected using at least one sensor.

24. The apparatus of claim 23, wherein, to determine the direction of the natural draft, the at least one processor is further configured to:
force air to flow in a first direction within the apparatus;
measure a first airflow caused by the forced air flowing in the first direction;
force air to flow in a second direction within the apparatus, wherein the second direction is different than the first direction;
measure a second airflow caused by the forced air flowing in the second direction; and
determine the direction of the natural draft based on the first airflow and the second airflow.

25. The apparatus of claim 24, wherein, to determine the direction of the natural draft, the at least one processor is further configured to:
compare the first airflow with the second airflow; and
select one of the first direction or the second direction as the determined direction of the natural draft based on the comparing of the first airflow with the second airflow.

26. The apparatus of claim 25, wherein:
the selected direction corresponds to the first direction when the first airflow is greater than the second airflow by a threshold criterion; and
the selected direction corresponds to the second direction when the second airflow is greater than the first airflow by the threshold criterion.

27. The apparatus of claim 25, wherein, to determine the direction of the natural draft, the at least one processor is further configured to:
determine the direction of the natural draft based on a detected orientation of the apparatus in response to a difference between the first airflow and the second airflow being less than a threshold value.

28. The apparatus of claim 23, wherein, to generate the airflow within the apparatus, the at least one processor is further configured to activate at least one fan within the apparatus, the at least one activated fan having an orientation generally aligned with the direction of the natural draft.

29. The apparatus of claim 28, wherein the at least one processor is further configured to select the at least one activated fan from a plurality of fans associated with the apparatus.

30. The apparatus of claim 21, wherein the apparatus is a mobile device.

31. A computer-readable medium storing computer executable code for managing a temperature, comprising code for:
determining a direction of a natural draft relative to a device; and
generating an airflow within the device in the direction of the natural draft.
